(19) United States
(12) Patent Application Publication
(10) Pub. No.: US 2026/0307937 A1
(43) Pub. Date: Oct. 8, 2026

(54) SYSTEM AND METHODS FOR REUTILIZATION OF ELEVATOR'S TRAVELING CABLE ON MODERNIZATIONS

(71) Applicant: KONE Corporation, Helsinki (FI)

(72) Inventor: Juan Pamanes, Allen, TX (US)

(73) Assignee: KONE Corporation, Helsinki (FI)

(21) Appl. No.: 19/172,962

(22) Filed: Apr. 8, 2025

(51) Int. Cl. B66B 1/30; B66B 1/34

(52) U.S. Cl. CPC B66B 1/30; B66B 1/3423

(57) ABSTRACT

A traveling cable provides high voltage and data communication to an elevator car. The high voltage is converted by transformers at the elevator car, reducing the number of conductors required in the traveling cable. In addition, data acquisition from sensors and analysis of the sensor signals is performed at the elevator car, reducing the number of data lines in the traveling cable. With the reduced requirements of the traveling cables, existing traveling cables provide the needed power and data lines for a modernized elevator car. New installation require a traveling cable having only a minimal number of power conductors and data lines.

### FIELD OF THE INVENTION

The invention relates to traveling cables for elevators and the upgrade and replacement of elevator cars using traveling cables.

### BACKGROUND OF THE INVENTION

Elevators cars require a lifting mechanism to support the elevator car and move the elevator car between floors. To raise and lower the elevator car, hydraulic mechanisms or a lifting cable wound onto a spool are often used to raise and lower the elevator car. However, elevator cars also require a traveling cable to supply power, video and audio data, sensor signals, control signals and other data to and from the elevator car.

When an elevator's control system is modernized, removal and replacement of the traveling cable is often mandatory due to the unique signal landscape utilized by different manufacturers over different periods of time. The existing traveling cable may not have enough conductors or meet the conductor's specification of the new control system to utilize the existing traveling cable.

In modernization, replacing the traveling cable is one of the most labor-intensive operations, with removal, installation and rewiring taking up to 16 hours of labor for two mechanics. This creates challenges on overall installation time and labor costs. This also increases the elevator's downtime and disruption to the occupants of building as the buildings are usually active while modernization is on-going.

Even if the existing traveling cable meets all the specific requirements for the new control system to function properly, identifying the conductors with their proper connections and rewiring multiple signals creates installation and variability challenges.

It is an object of the invention to provide a traveling cable with a minimal amount of conductors for power and data.

It is another object of the invention to provide an elevator car requiring less conductors for power and data.

It is yet another object of the invention to utilize existing traveling cables with modernized elevator cars.

It is still another object of the invention to facilitate elevator car replacement by using an existing traveling cable with the new elevator car.

### SUMMARY OF THE INVENTION

The system and method transfers functionality to the elevator car, reducing the requirements of the traveling cables. The elevator car may have transformers to alter the voltage of the received power. In that way, the traveling cable only needs to provide power in one voltage. The transformers provide the needs of the elevator car for different voltages. Therefore, the traveling cable only needs high voltage conductors. The transformers convert the high voltage to any needed voltage, such as 110 volts or low voltage. In addition, the elevator car can have a computer to perform analysis and control from sensor signals. The sensor signals include the position of the elevator car within the elevator shaft, the position of the elevator doors and other parameters needed for the operation of the elevator car. Also, also data signals are sent through a single type of data conductor. When needed, data signals are converted to a format suitable for the data conductor.

The reduced requirements of the traveling cable allow existing traveling cables to be reused with updated elevator cars, as the existing traveling cables have more than enough conductors to provide all power and data needs for the elevator car. In addition, the reduced number of active conductors simplifies the connection of the existing traveling cable to the updated elevator car. Moreover, newly installed traveling cables have fewer conductors. A newly installed traveling cable only needs conductors attached to a single voltage source, such as high voltage, to supply power needs and one type of data conductor, such as an ethernet cable, for data signals.

The system simplifies the requirement of a traveling cable. Specifically, only one voltage, such as high voltage, is transmitted to the elevator car. Only data that can be transmitted over an ethernet conductor is transmitted to and from the elevator car. Data signals are converted to ethernet-ready signals and data conductors having ethernet-ready signals connect to an interface such as a media convertor to transfer the signals to an ethernet cable. By using one voltage value and only an ethernet cable, the requirements of a traveling cable are minimized. These requirements can be met by an existing traveling cable or a newly installed traveling cable having only the conductors necessary for one voltage value and ethernet ready data signals.

Further scope of applicability of the present application will become more apparent from the detailed description given hereinafter. However, the detailed description and specific examples, while indicating preferred embodiments of the invention, are given by way of illustration only, and various changes and modifications within the spirit and scope of the invention will become apparent to those skilled in the art.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 is a schematic view of the system having an elevator car and traveling cable.

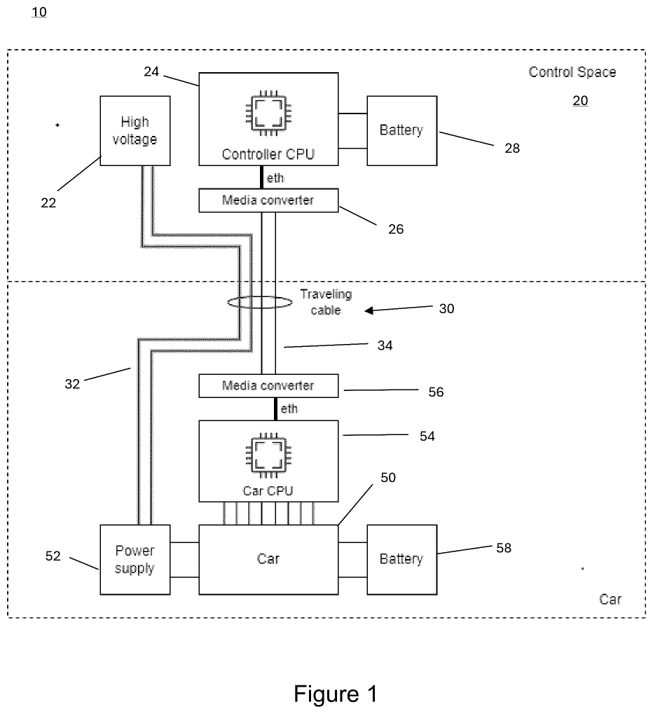

### DETAILED DESCRIPTION OF THE INVENTION

The elevator system 10 includes a control space 20, a traveling cable 30 and an elevator car 50. The control space can be in a machine room housing the motor and lifting cable. The control space includes a power source 22, a system controller 24, a control media convertor 26 and a battery 28.

The system controller 24 controls all aspects of the elevator car, including signals to move the elevator car between floors, open and close the doors, and provide communication with the elevator car. The communication includes messages and entertainment provided to video screen in the elevator car and well as alarm and phone signals received from the elevator car. The system controller 24 also receives and transmits all other data needed for the operation of the elevator car. The system controller 24 is hardware capable of executing algorithms needs to perform functions associated with the operation of the elevator system 10. The system controller 24 may be a central processing unit (CPU). The system controller and control media convertor 26 also make needed conversions so that the traveling cable can have one type of data conductor, as will be explained in more detail later. The system controller 24 and the control media convertor 26 can be formed as a single unit, thereby negating the need for a data conductor between the system controller 24 and the control media converter 56.

The power source 22 is preferable a high voltage source, such as 230V, to provide the power required by the elevator car during operation. The control space also includes a battery 28 to supply power in the event of a power interruption. The battery 28 stores power that can be delivered to the controller 24. The battery 28 can be a rechargeable battery receiving power during normal power supply and used in the case of a power disruption. The power can be received from the power source 22 or another power line located in the control space.

The power supply 52 of the elevator car connects to the power source 22 by power conductors 32 of the travelling cable 30. There are preferably two power conductors to supply the necessary power to the power supply 52. The power supply 52 includes a voltage convertor, such as a step-down transformer coil or a step-up transformer coil. In this way, the single voltage provided by the power supply 22 can be converted to any voltage needed by the elevator car 50. The elevator car also includes a battery 58 to supply power to the elevator car in the event of a loss of power from the power supply 22. The battery 58 stores power that can be delivered to elements of the elevator car, including a phone or intercom, emergency lighting and alarm system, as well as opening the doors, if necessary. The battery 58 can be a rechargeable battery receiving power during normal power supply to maintain a charge. The battery receives power from the power supply 52 under normal conditions, that is, power provided by the power supply 22, and supplies power when power to the power supply 52 is interrupted. There is no need for a separate power conductor in the traveling cable to deliver power from the power source 22 to the battery 58.

Data also needs to be communicated though the traveling cable. To reduce the requirements of the traveling cable, only one type of data conductor is used, such as an ethernet cable. In this case, any signal not suitable for the data conductor of the traveling cable needs to be converted. In addition, any other type of data conductor in the elevator car will need to connect to an interface with the data conductor of the traveling cable. The conductors of an existing traveling cable can be used as a twisted pair to act as an ethernet cable.

The elevator car includes a car controller 54 to receive and process data, such as signals from sensors for the car position in the hoistway and the position of the car doors. The car controller 54 is hardware capable of executing algorithms needs to perform functions associated with the operation of the elevator car. The car controller 54 can be a single CPU performing all needed functions or can be separate CPUs, each performing different functions needed for the operation of the elevator car. The car controller 54 performs as much data analysis as possible to reduce the amount of data sent to the system controller 24. One of the functions of the car controller 54 is to convert any data signal to a format that can be transmitted over the data conductor of the travel cable. For instance, voice data received through a phone in the elevator car, usually installed for emergency purposes, can be converted to a VoIP signal that can be transmitted over an ethernet cable of the traveling cable. Therefore, the car controller 54 connects to a car media convertor 56 by an ethernet conductor to transmit the converted signals. The car controller 54 and the car media convertor 56 can be formed as a single unit, thereby negating the need for a data conductor between the car controller 54 and the car media convertor 56.

The car controller 54 connects to a car media converter 56 which in turn connects to the control media convertor 26 by data lines 34 of the traveling cable. The control media convertor 26 can connect to the car controller by an ethernet connection. The car media convertor 56 receives data signals exchanged between the elevator car and control space. In addition to receiving converted data signals from the car controller, the car media converter 56 receives ethernet ready signals that do not need to be converted. When these signals are carried by data conductors other than the type of data conductor of the traveling cable, the media convertors acts as an interface between the different types of data conductors. Different types of data conductors that connect to the media converters include fiber optic cable, coaxial cables and copper wire. For instance, the media convertors 26, 56 can be an interface between a fiber optic cable and the ethernet cable of the traveling cable. The media convertor can be a processor chip integrated into the controller boards or a separate component and may use one twisted pair for ethernet to transmit and receive data signals. As noted above the media convertors 26, 56 and controllers 24, 54 can be a single unit.

The car media converter 56 and car controller 54 also act in a similar manner for data received through the traveling cables. The car media converter allows the data signals to be transmitted to elements in the elevator car though other types of data conductors other than the type of data conductor used in the traveling cable. The car controller converts data signals to other formats to allow the signals to be send to other elements of the elevator car. Using the previous example, a VoIP signal received through the traveling cable can be converted to a signal appropriate for the phone in the elevator car, if needed. Just as the car media converter 56 and car controller 54 perform the necessary conversions for data transmitted to and received from the traveling cable, the system controller 24 and control media convertor 26 convert perform the necessary conversions for data transmitted to and received at the other end of the traveling cable.

By implementing ethernet based communications, multiple requirements of the traveling cable, such as one shielded twisted pair for communication, one shielded twisted pair for alarm phone voice, and two conductors for Alarm and “Help is coming” signals and CAT 5e cable for other connectivity requirements, the data conductors can be simplified to only two conductors in the traveling cable. The specifications of those conductors can be a wide range of options depending on the media converter technology selected.

The traveling cable between the control space and elevator car needs a minimal number of components. For example, two power conductors can supply the needs power from the power source 22 to the power supply 52. Only two conductors may be needed to transmit the data signals between the control media convertor 26 of the control space and the car media convertor 56 of the elevator car. An advantage of the reduced number of components is the ability to use existing traveling cables when the elevator car is modernized to have the power supply 52 and car media convertor 56. The conventional traveling cables have a larger number of cables so the conductors of the existing traveling cable can be used with the modernized elevator car. As the power conductors each connect to the power source 22 to the power supply 52, connection is simple, as there is no confusion as to where opposite ends of a power conductor are connected. Similarly, the conductor used for data transfer also connects between the control media convertor 26 of the control space and the car media convertor 56 of the elevator car, making connection of the data conductor simple.

The invention thus being described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An elevator system comprising:
a control space, the control space having a power source providing power at a first voltage,
an elevator car, the elevator car having a power supply, the power supply having a voltage convertor receiving the first voltage and supplying power at a second voltage different than the first voltage; and
a traveling cable, the traveling cable having power conductors to transmit the first voltage from the power source to the power supply and data lines to transmit data signals.

2. The elevator system of claim 1, wherein the voltage converter is a step-down transformer.

3. The elevator system of claim 1, wherein the elevator car further comprises a car central processing unit and a car media convertor connected to the car central processing unit.

4. The elevator system of claim 3, wherein the control space further comprises a controller central processing unit and a control media convertor connected to the controller central processing unit.

5. The elevator system of claim 4, wherein the traveling cable further comprises a data conductor extending between the control media convertor of the control space and the car media convertor of the car.

6. The elevator system of claim 1, further comprising a rechargeable battery, the rechargeable battery receiving power from the power supply.

7. The elevator system of claim 3, wherein the car central processing unit converts an analog voice signal to a VoIP signal.

8. The elevator system of claim 4, wherein the car central processing unit and the car media convertor are a single unit, and
wherein the car central processing unit and the car media convertor are a single unit.

9. An elevator car, comprising:
a power supply, the power supply having a voltage convertor configured to receive a first voltage and supplying power at a second voltage different than the first voltage; and
a central processing unit; and
a media converter acting as an interface between different types of data conductors.

10. The elevator car of claim 9, further comprising a rechargeable battery, the rechargeable battery receiving power from the power supply.

11. The elevator car of claim 9, further comprising a first data conductor extending from the media convertor, the first data conductor capable of connecting to a system controller.

12. The elevator car of claim 11, further comprising at least one second data conductor extending to the media convertor, the first data conductor and the at least one second data conductor being different types of data conductors.

13. The elevator car of claim 11, wherein the first data conductor is a twisted pair.

14. The elevator car of claim 9, wherein the central processing unit and the media convertor are a single unit.

15. The elevator car of claim 9, wherein the central processing unit converts an analog voice signal to a VoIP signal.

16. A method of modernizing an elevator car, comprising:
disconnecting a traveling cable from the elevator car, the traveling cable having a plurality of power conductors and a plurality of data conductors;
install an updated elevator car;
attaching the traveling cable to the updated elevator car, wherein attaching the traveling cable to the updated elevator car comprises:
attaching a first power conductor of the plurality of power conductors to a transformer of the updated elevator car; and
attaching a first data conductor of the plurality of data conductors to a media convertor of the updated elevator car.

17. The method of claim 16, wherein the first power conductor is a high voltage power conductor.

18. The method of claim 16, wherein the transformer is a step-down transformer to reduce voltage received from the first power conductor.

19. The method of claim 16, wherein the first data conductor is a twisted pair.

20. The method of claim 16, further comprising converting an analog voice signal to a VoIP signal.
